(19) United States
(12) Patent Application Publication
(10) Pub. No.: US 2008/0054626 A1
(43) Pub. Date: Mar. 6, 2008

(54) Fitting for fluid conduits

(75) Inventors: Mark D. Bearer, Akron, OH (US); Theodore J. Gausman, Concord, OH (US); John D. Karkosiak, Broadview Heights, OH (US); Peter C. Williams, Cleveland Heights, OH (US); Tobin Berry, Chagrin Valls, OH (US); Andrew P. Marshall, University Heights, OH (US)

Correspondence Address: CALFEE HALTER & GRISWOLD, LLP, 800 SUPERIOR AVENUE, SUITE 1400, CLEVELAND, OH, 44114, US

(73) Assignee: Swagelok Company, Solon, OH (US)

(21) Appl. No.: 11/897,437

(22) Filed: Aug. 30, 2007

Related U.S. Application Data
(60) Provisional application No. 60/841,812, filed on Sep. 1, 2006.

(51) Int. Cl. F16L 35/00

(52) U.S. Cl. 285/39

(57) ABSTRACT

A fitting for a conduit is provided with first and second fitting components, a gripping member, and a live-loading mechanism. The first fitting component is adapted to receive a conduit along a central axis. The gripping member includes a gripping portion adapted to engage the conduit when the gripping member is tightened to the conduit. The second fitting component is adapted to be joined to the first fitting component to provide a seal between the gripping member and at least one of the first and second fitting components. The live-loading mechanism is adapted to hold the gripping portion in live-loaded engagement with the conduit when the first fitting component is separated from the second fitting component.

### CROSS-REFERENCE TO RELATED APPLICATION

This application claims the benefit of United States provisional patent application Ser. No. 60/841,812, entitled FITTING FOR FLUID CONDUITS and filed Sep. 1, 2006, the entire disclosure of which is fully incorporated herein by reference.

### BACKGROUND OF THE DISCLOSURE

Fittings are used to join or connect a conduit to another member, whether that other member be another conduit such as through T-fittings and elbow fittings, for example, or a device configured to be in fluid communication with the conduit, such as, for example, a valve. The term conduit as used herein includes, but is not limited to, metal tube and pipe. A fitting is typically configured to accomplish at least two functions within the pressure, temperature and vibration criteria that the fitting is designed to meet. First, the fitting is configured to grip the conduit so as to prevent loss of seal or blow out. Secondly, the fitting is configured to maintain a primary seal against leakage. The accomplishment of these two functions has been the driving factor in fitting design for decades. A multitude of factors influence the design of a fitting to meet a desired grip and seal performance criteria, but basic to any fitting design will be: 1) the characteristics of the conduit that the fitting must work with, including the material, outside diameter and wall thickness; and 2) the grip and seal performance level required of the fitting for its intended applications.

Fittings may include an assembly of: 1) a conduit gripping device, often in the form of a ferrule or ferrules, or a gripping ring-like structure, and 2) a pull-up mechanism for causing the gripping device to be installed on a tube end so as to grip the conduit and provide a seal against leakage. The term “pull-up” simply refers to the operation of tightening the fitting assembly so as to complete the assembly of the fitting onto the conduit with the desired grip and seal. During pull-up, the fitting typically undergoes plastic and elastic deformation.

### SUMMARY

In accordance with one inventive aspect of the present application, a gripping arrangement for a fitting is provided that maintains live-loaded engagement between a conduit gripping member, such as, for example, a ferrule, collet, or olive, and a conduit, such as tube or pipe. As used herein, “live-loaded engagement” refers to a condition in which stored energy within an arrangement imparts a force directed towards engagement of two or more components, such as, for example, a gripping member and a conduit. This live-loaded engagement may, for example, be maintained after the fitting has been disassembled, or after a tightening force has been reduced or withdrawn from the gripping member. By preserving live-loaded engagement between the gripping member and the conduit, the gripping arrangement may eliminate elastic movement of the gripping member with respect to the conduit, for example, upon fitting disassembly, and/or the need to re-establish a grip or seal between the components upon fitting reassembly, which may otherwise require additional tightening forces and/or additional deformation of sealing or gripping surfaces.

In one embodiment, a conduit gripping member of a fitting is adapted to be tightened to a conduit. A gripping portion of the gripping member engages the conduit when the gripping member is tightened to the conduit. A locking or retaining live-loading mechanism retains, locks, or otherwise holds the gripping portion in live-loaded engagement with the conduit when the gripping member is no longer being tightened to the conduit, such as, for example, when the fitting is disassembled from the conduit by loosening or separating first and second fitting components (e.g., a fitting body and nut). In one embodiment, the live-loading mechanism may be integral to the gripping member. In other embodiments, the live-loading mechanism may include one or more other fitting components, such as, for example, a separate live-loading member assembled with the fitting to provide the live-loading mechanism.

Further advantages and benefits will become apparent to those skilled in the art after considering the following description and appended claims in conjunction with the accompanying drawings.

### BRIEF DESCRIPTION OF THE DRAWINGS

FIG. 1A is a partial cross-sectional schematic view of an exemplary fitting including first and second fitting components assembled to a conduit with a conduit gripping arrangement;

FIG. 1B is a partial cross-sectional schematic view of the conduit gripping arrangement of FIG. 1A assembled with the conduit after disassembly of the fitting;

FIG. 2A is a partial cross-sectional view of an example of a tube gripping arrangement having an integral live-loading mechanism;

FIG. 2B is a partial cross-sectional view of an example of a tube fitting including the tube gripping arrangement of FIG. 2A in a tightened condition;

FIG. 3A is a partial cross-sectional view of an example of a tube gripping arrangement having a pivoting gripping member in an un-tightened condition;

FIG. 3B is a partial cross-sectional view of an example of a tube fitting including the tube gripping arrangement of FIG. 3A in a tightened condition;

FIG. 4 is a partial cross-sectional view of an example of a tube gripping arrangement having a live-loading member that interlocks with a gripping member;

FIG. 5 is a partial cross-sectional view of an example of a tube gripping arrangement having a live-loading member that receives and engages a gripping portion of a gripping member;

FIG. 6 is a partial cross-sectional view of an example of a tube gripping arrangement having a first live-loading member that interlocks with a second live-loading member to engage a gripping member;

FIG. 7 is a partial cross-sectional view of an example of a tube gripping arrangement having a live-loading member adapted to flare a tube end into engagement with a gripping member;

FIG. 8 is a partial cross-sectional view of an example of a tube gripping arrangement having a live-loading member adapted to barrel a tube end into engagement with a gripping member;

FIG. 9 is a partial cross-sectional view of an example of a tube gripping arrangement having a live-loading member adapted to pivot a gripping member into engagement with a tube end;

FIG. 10 is a partial cross-sectional view of an example of a tube gripping arrangement having a live-loading member adapted to engage a tube end and to pivot a gripping member into engagement with the tube end;

FIG. 11A is a partial cross-sectional view of an example of a tube gripping arrangement in an un-tightened condition, the arrangement having a live-loading member adapted to pivot into engagement with a tube end and to pivot a gripping member into engagement with the tube end;

FIG. 11B is a partial cross-sectional view of an example of a tube fitting including the tube gripping arrangement of FIG. 11A in a tightened condition;

FIG. 12A is a partial cross-sectional view of an example of a tube gripping arrangement in an un-tightened condition, the arrangement having a live-loading member adapted to pivot into engagement with a tube end and to pivot a gripping member into engagement with the tube end;

FIG. 12B is a partial cross-sectional view of the tube gripping arrangement of FIG. 12A in a partially tightened condition;

FIG. 12C is a partial cross-sectional view of an example of a tube fitting including the tube gripping arrangement of FIG. 12A in a tightened condition; and

FIG. 13 is a partial cross-sectional view of an example of a tube gripping arrangement having a live-loading member adapted to engage a tube end and to receive a gripping member to hold the gripping member in engagement with the tube end.

### DETAILED DESCRIPTION

The present application relates to conduit gripping arrangements that may be used with many types of fittings, such as, for example, tube fittings, and with many types of conduits, including, for example, many types of tubing and pipe. While the fittings of the exemplary embodiments described herein are each described as including a fitting body and nut that may be assembled with a tube, many different fitting arrangements may be used with the aspects of the present application, including fittings having one or more body components, and different types of coupling arrangements, including, for example, threaded connections, clamping connections, and push-to-connect arrangements. One exemplary fitting includes a threaded coupling body, a threaded coupling nut, and an annular tube gripping member. The nut is assembled with the body. The tube gripping member is assembled within a cavity formed by the fitting body and the nut.

According to one inventive aspect of the application, a conduit gripping arrangement includes a gripping member having a gripping portion that grips and/or seals with a conduit when the gripping member is tightened to the conduit by a tightening arrangement, such as, for example, a fitting assembled with the gripping member, or a tool used to clamp or tighten the gripping member on the conduit. While the gripping portion may function both to grip the fitting to the conduit and seal with the conduit, the gripping portion of some embodiments may function primarily or exclusively to grip the conduit, with a separate sealing member provided for sealing the fitting with the conduit. Alternatively, the gripping portion may function primarily or exclusively to seal the fitting with the conduit, with an additional gripping member provided to grip the fitting to the conduit. The gripping arrangement further includes a live-loading mechanism that holds the gripping portion in gripping and/or sealing engagement with the conduit. The live-loading mechanism may continue to hold the gripping portion in gripping and/or sealing engagement with the conduit when the gripping member is no longer being tightened to the conduit; for example, after clamping forces from a tightening arrangement have been reduced or withdrawn, or after a fitting assembled with the gripping member has been disassembled. To maintain gripping and/or sealing engagement between the gripping member and the conduit under such conditions, the live-loading mechanism may be configured to hold the gripping portion in live-loaded engagement with the conduit, in which a state of mechanically energized contact is maintained between the gripping portion and the conduit. This continued engagement may eliminate the need to re-establish a grip or seal between the gripping member and the conduit upon reassembly of the fitting, a process which may require additional deformation of conduit and gripping member sealing surfaces, as well as additional assembly torque of the fitting to re-establish this engagement.

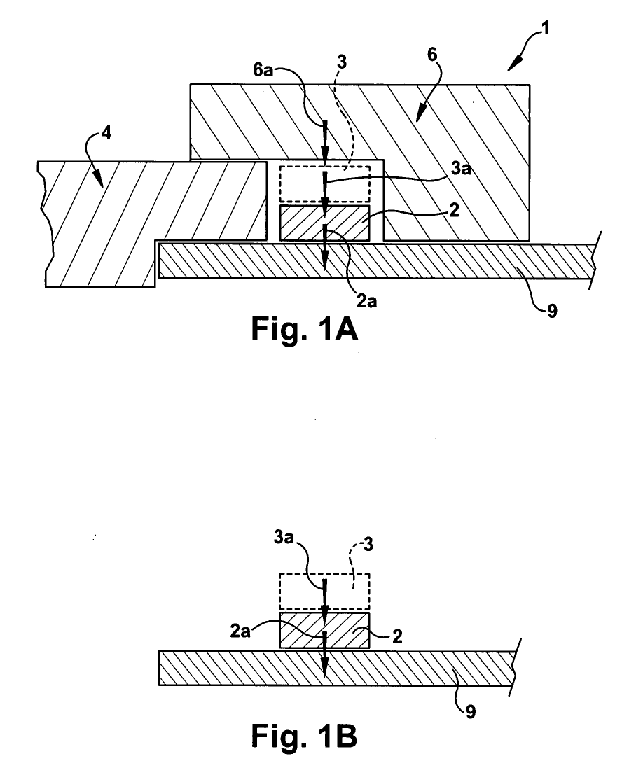

FIG. 1A schematically illustrates an upper half portion of a cross-section of an exemplary fitting 1. As with the remaining FIG. 1B-13, only one half of the fitting cross-section is shown, it being recognized by those skilled in the art that the other half of the view may be identical about a longitudinal center line. In the example illustrated by FIG. 1A, the fitting 1 includes a first coupling component, such as a fitting body 4, a second coupling component, such as a fitting nut 6, an annular gripping member 2, such as, for example, a ferrule, collet, or olive, and a live-loading mechanism, represented in phantom at 3. The exemplary nut 6 is assembled with the body 4 onto a conduit 9. The annular gripping member 2 is assembled between the body 4 and the nut 6. In the example illustrated by FIGS. 1A and 1B, the gripping member 2 engages the conduit 9, for example, with a gripping and/or sealing engagement, shown schematically at 2a. This engagement may be produced when the gripping member 2 is tightened to the conduit 9 by a tightening arrangement. Many different tightening arrangements may be used to tighten the gripping member 2 to the conduit 9. In one embodiment, a tool, such as pliers or a clamp or vice, may be used to tighten the gripping member 2 to the conduit 9 prior to fitting installation. In another embodiment, internal surfaces of one or more fitting components, such as the body 4 or nut 6, may tighten the gripping member 2 onto the conduit 9 upon initial pull-up of the fitting 1. For example, in the schematic illustration of FIG. 1A, the nut 6 is configured to tighten the gripping member 2 onto the conduit 9, as shown schematically by arrow 6a. In yet another embodiment, a fitting body and nut or other threaded coupling may be joined or tightened onto the gripping member to tighten the gripping member for future assembly with a different threaded coupling. Examples of internal fitting surfaces configured to tighten a gripping member to a conduit are disclosed in co-pending PCT application Ser. No. PCT/JUS06/24776, filed Jun. 26, 2006 (hereinafter the '776 application), the entire disclosure of which is incorporated herein by reference. As with any of the more specific embodiments described herein, the conduit 9, body 4, nut 6, and gripping member 2 may be constructed from many different materials, including metals such as, for example, stainless steels, nickel alloys, and copper alloys.

The exemplary live-loading mechanism 3, which may be integral with the gripping member 2 or may include another component of the fitting 1, holds the tightened gripping member 2 in live-loaded engagement with the conduit 9. As such, this gripping and/or sealing engagement may be maintained after clamping or tightening forces have been reduced or withdrawn from the gripping member 2 (i.e., when the gripping member is no longer being tightened to the conduit), such as when the tightening arrangement has been loosened or withdrawn from the tightened gripping member 2, or after the fitting 1 has been loosened or disassembled from the gripping member 2, as shown schematically in FIG. 1B. While the schematic illustration of the live-loading mechanism 3 in FIG. 1A and 1B shows the live-loading mechanism 3 as directly radially outward of the gripping member 2, the live-loading mechanism 3 may be located anywhere in the fitting 1, including within the gripping member 2, from which an elastic gripping force can direct the gripping member 2 into gripping and/or sealing engagement with the conduit 9.

According to one inventive aspect of the present application, the live-loading mechanism 3 includes a component or a portion of a component that can become flexed or live-loaded, such as during tightening of the gripping member 2 to the conduit 9. While the resulting deformation of the component may, but need not, be partially plastic deformation, an elastic component of the deformation produces a flexed or live-loaded condition in which energy is stored in the component. As a result of this elastic deformation or flexure, the stored energy of the flexed component applies a gripping or retaining force, shown, for example, by arrow 3a, to the gripping member 2 to maintain the gripping and/or sealing engagement with the conduit 9 even upon fitting disassembly. While schematically illustrated as being directed perpendicular to the surface of the conduit 9, the gripping force 3a or forces may be directed in one or more of many different orientations or angles with respect to the conduit 9 to achieve the desired gripping and/or sealing engagement.

In one such example, deformation of the live-loaded component may involve deformation through a condition of higher load or elevated mechanical potential energy to a condition of reduced load or less elevated mechanical potential energy-movement that may be comparable to the movement of a toggle joint. While the reduced load (or live-loaded) condition retains greater mechanical potential energy than the pre-tightened gripping member 2 (FIG. 1A), and provides sufficient gripping forces to maintain the desired engagement between the gripping member 2 and the conduit 9, the tendency for the elastically deformed gripping member 2 to bias away from the higher load condition inhibits the gripping member 2 from passing through the higher load condition to return to the un-flexed or non-live-loaded condition. As such, the flexed or live-loaded condition of the gripping member 2 may be maintained even without additional external forces, such as from the assembled fitting 1.

When the tightening arrangement, such as a fitting assembly or clamping tool, has been withdrawn from the gripping member, the flexed component may co-act with any one or more of the conduit 9, the gripping member 2 or other components to maintain the flexed condition of the flexing component, thereby maintaining the gripping force 3a applied to the gripping member 2. While this gripping force 3a may be equivalent to a gripping force applied to the gripping member 2 by the assembled fitting 1, the flexed component may also apply a reduced gripping force 3a, which may still be sufficient to maintain a desired engagement between the gripping member and the conduit.

As indicated above, the live-loading mechanism may be provided in many different fitting components or combinations of components. In one embodiment, the live-loading mechanism is integral with or a part of a gripping member. As one example, a conduit gripping member may elastically flex when tightened against a conduit by a tightening arrangement, resulting in stored energy within the gripping member. When the tightening arrangement has been withdrawn from the gripping member, the stored elastic energy within the gripping member causes the gripping member to maintain gripping and/or sealing engagement with the conduit.

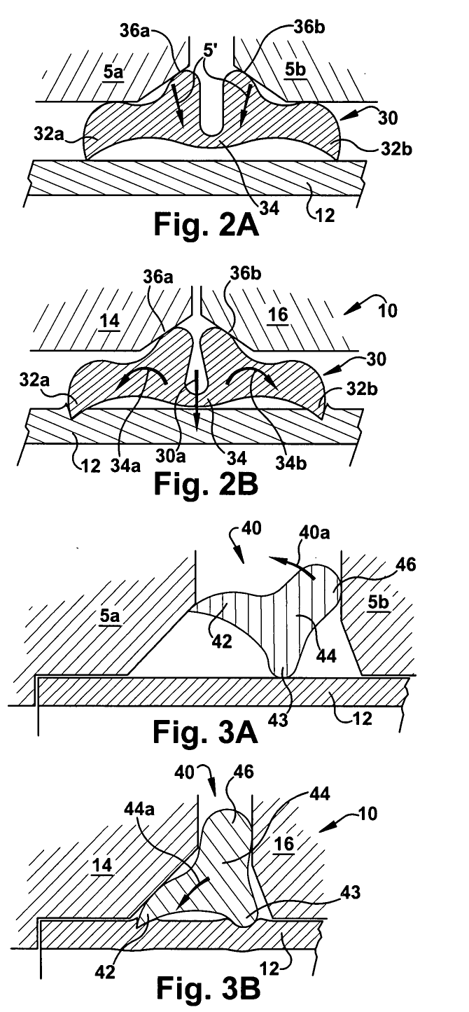

FIGS. 2A and 2B illustrate a partial cross-section of an exemplary embodiment of a tube gripping member 30. The exemplary annular tube gripping member 30 is provided with first and second gripping portions 32a, 32b, a flexing portion or web 34, and first and second fitting engaging portions 36a, 36b. As shown in FIG. 2A, the exemplary tube gripping member 30 may be tightened to a tube 12 using a tightening arrangement shown schematically at 5a, 5b, which applies a clamping or tightening force 5′ to the gripping member 30, for example, at fitting engaging portions 36a, 36b. As indicated above, this tightening arrangement may alternatively include many different tools or components. In one embodiment, the tightening arrangement 5a, 5b includes a fitting body and nut, such as the fitting body 14 and nut 16 shown schematically in FIG. 2B. In another embodiment, the tightening arrangement may include a clamping tool, which may, for example, be similar to a pair of pliers, configured to engage the outer circumference of the annular gripping member 30 and clamp the gripping member 30 into a tightened condition.

The tightening force 5′, which may be directed at least partly radially into the tube 12, for example, by using chamfered or angled clamping surfaces on an axially compressing tightening arrangement causes the gripping portions 32a, 32b to plastically deform an outer surface of the tube 12, such as, for example, by cutting, indenting, or burnishing the tube surface. This plastic deformation may create a gripping and/or sealing engagement between the gripping portions 32a, 32b and the tube 12. The clamping or tightening force 5′ axially compresses the first and second fitting engaging portions 36a, 36b and causes the web portion 34 to flex or elastically deform into a flexed condition, as shown in FIG. 2B. When the clamping force 5′ is reduced or withdrawn from the tube gripping member 30, the flexed or live-loaded web portion 34 exerts gripping forces 34a, 34b on the gripping portions 32a, 32b to maintain a live-loaded gripping and/or sealing engagement with the tube 12. These gripping forces 34a, 34b may also co-act with the tube 12 to maintain the gripping member 30 in the flexed or live-loaded condition.

In deforming the web portion 34 during tightening of the gripping member 30 to the tube 12, the web portion may pass through a higher load or higher mechanical potential energy condition before being deformed to a reduced load condition, this motion being represented schematically by arrow 30a. While the reduced load (or live-loaded) condition provides sufficient gripping forces 34a, 34b to maintain the desired engagement between the gripping member 30 and the tube 12, the tendency for the web portion 34 to bias away from the higher load condition inhibits the gripping member 30 from moving out of the live-loaded condition and passing through the higher load condition to return to the un-flexed or non-live-loaded condition. As such, the flexed or live-loaded condition of the gripping-member 30 may be maintained without additional external forces.

When a fitting 10 is assembled with the tube gripping member 30 on a tube 12, either upon initial pull-up or re-make of the fitting 10, as shown in FIG. 2B, the fitting body 14 and nut 16 are axially tightened against the tube gripping member 30 to seal the fitting body 14 against the fitting engaging portion 36a of the tube gripping member 30, while the seal between the gripping member 30 and the tube 12 is maintained to complete the seal between the tube 12 and the fitting 10.

Many types of live-loading mechanisms may be provided to store energy in a fitting to maintain a gripping and/or sealing engagement between the gripping member and the conduit. In one embodiment, a gripping member may pivot into gripping engagement with a conduit when the gripping member is tightened against the conduit. In the exemplary embodiment of FIGS. 3A and 3B, an annular tube gripping member 40 is provided with a gripping portion 42, a hinge portion 43, a flexing portion 44, and a fitting engaging portion 46. In the tube gripping member's un-tightened condition, as shown in FIG. 3A, the gripping portion 42 is oriented away from the tube 12. When a tightening arrangement 5a, 5b is clamped against the tube gripping member 40, the gripping portion 42 and fitting engaging portion 46 are pivoted about the hinge portion 43, shown by arrow 40a, elastically deforming the flexing portion 44 and directing the gripping portion 42 into engagement with the tube 12 to plastically deform the tube 12 for gripping and/or sealing engagement. The flexing portion 44 exerts a rotational gripping force shown by arrow 44a, which maintains the gripping and/or sealing engagement of the gripping portion 42 with the tube 12. The gripping force 44a and hinge portion 43 of the flexed gripping member 40 may also co-act with the tube 12 to maintain the gripping member 40 in the flexed or live-loaded condition.

In deforming the flexing portion 44 during tightening of the gripping member 40 to the tube 12, the flexing portion 44 may pass through a higher load or higher mechanical potential energy condition before being deformed to a reduced load condition. While the reduced load (or live-loaded) condition provides a sufficient gripping force 44a to maintain the desired engagement between the gripping member 40 and the tube 12, the tendency for the flexing portion 44 to bias away from the higher load condition inhibits the gripping member 40 from moving out of the live-loaded condition and passing through the higher load condition to return to the un-flexed or non-live-loaded condition. As such, the flexed or live-loaded condition of the gripping member 40 may be maintained without additional external forces.

When a fitting 10 is assembled with the tube gripping member 40 on a tube 12, either upon initial pull-up or re-make of the fitting, as shown in FIG. 3B, the fitting body 14 and nut 16 are tightened against the tube gripping member 40 to seal the body 14 against the gripping portion 42, while the seal between the gripping member 40 and the tube 12 is maintained to complete the seal between the tube 12 and the fitting 10. As shown in FIG. 3B, the hinge portion 43 may also plastically deform the tube 12, which may provide a secondary gripping and/or sealing engagement between the gripping member 40 and the tube 12. Other hinge-action or pivoting tube gripping members are disclosed in the '776 application.

According to another inventive aspect of the present application, a locking mechanism may be provided in another fitting component assembled with a conduit gripping member to hold a gripping portion of the gripping member in live-loaded gripping and/or sealing engagement with a conduit. In one embodiment, an annular live-loading member is assembled with a gripping member when the gripping member is tightened to a conduit, such that the live-loading member holds the gripping portion in engagement with the conduit. The live-loading member may be adapted to provide a sustained or permanent gripping force to the gripping portion of the conduit gripping member when the clamping force from a tightening arrangement has been reduced or withdrawn from the conduit gripping member, and/or when the fitting has been disassembled from the conduit. As with the conduit and other fitting components, the live-loading member may be constructed from many different materials, including metals such as, for example, stainless steels, nickel alloys, and copper alloys.

Many different types of live-loading members may be used with a conduit gripping member to provide a sustained gripping force. In one embodiment, a live-loading member may flex or elastically deform to interlock with a conduit gripping member. In the illustrated example of FIG. 4, a tube gripping member 120 includes a gripping portion 122, a first interlocking portion 124, and a fitting engaging portion 126. A live-loading member 150 is provided with a tube engaging portion or shoulder 152, a second interlocking portion 154, a fitting engaging portion 156, and a camming portion 158. When the tube gripping member 120 is tightened to the tube 12, the gripping portion 122 engages the tube 12 and the interlocking portion 124 pivots outward towards engagement with the interlocking portion 154 of the live-loading member 150. One or both of the first and second interlocking portions 124, 154 are flexed or elastically deformed to engage each other, while the camming portion 158 of the live-loading member 150 directs the gripping portion 122 to plastically deform the tube 12 to provide gripping and/or sealing engagement with the tube 12. The stored energy of one or both of the flexed interlocking portions 124, 154 exerts a gripping force shown by arrow 154a, which maintains the live-loaded gripping and/or sealing engagement of the gripping portion 122 with the tube 12. The tube 12 and gripping member 120 may also co-act with the live-loading member 150 to maintain the live-loading member 150 in the flexed or live-loaded condition.

When a fitting is assembled with the tube gripping member 120 on a tube 12, either upon initial pull-up or re-make of the fitting, the fitting body (not shown) and nut 16 are tightened against the live-loading member 150 and tube gripping member 120. In the illustrated embodiment, the fitting body of the assembled fitting seals against the fitting engaging portion 156 of the live-loading member 150. Seals may also be achieved between one or both of the live-loading member shoulder 152 and the tube 12, and the live-loading member camming surface 158 and the tube gripping member 120. In another embodiment (not shown), the tube gripping member may be integral with the nut, such that the nut/tube gripping member and live-loading member remain locked on the tube when the fitting is disassembled.

In addition to cooperating with the live-loading member 150 to hold the tube gripping member 120 against the tube 12, the shoulder 152 may serve to axially align the tube when it is inserted into the fitting, or to reinforce the tube end during fitting pull-up to prevent excessive deformation of the tube end.

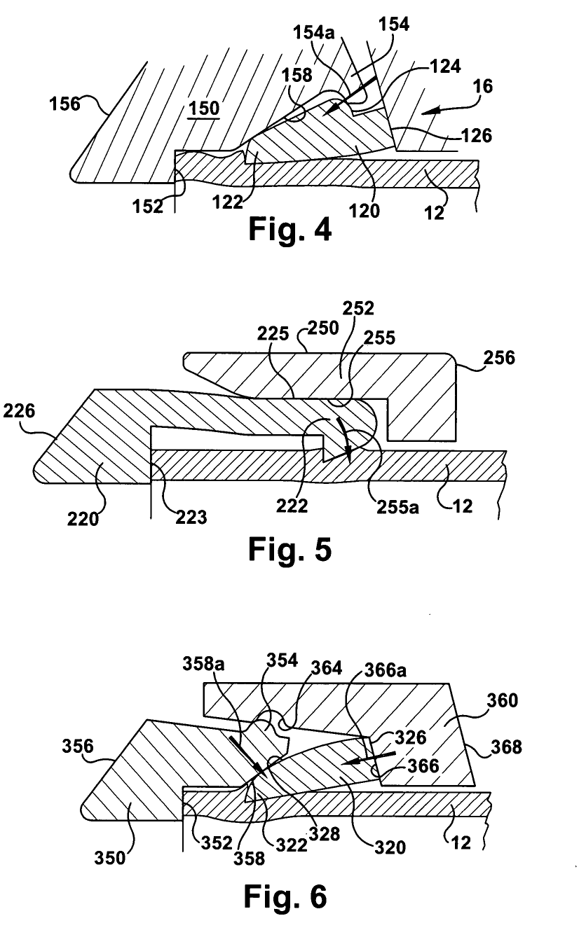

In another embodiment, a live-loading member may include an annular recess or gap adapted to receive a gripping portion of a gripping member and deflect or deform the gripping portion into gripping and/or sealing engagement with a conduit. In the illustrated example of FIG. 5, a tube gripping member 220 includes a rearward projecting gripping portion 222, a tube engaging shoulder 223, a driven surface 225, and a fitting engaging portion 226. An annular live-loading member 250 is provided with a recessed portion 252, a drive surface 255, and a fitting engaging portion 256. When the tube gripping member 220 is tightened to the tube 12, such as through pull-up of a fitting or any suitable tightening arrangement, the live-loading member 250 is axially pushed into engagement with the tube gripping member 220, and the drive surface 255 pushes against the driven surface 225 to flex the gripping portion into gripping and/or sealing engagement with the tube 12. An interference fit between the gripping portion 222 and the recessed portion 252 may be provided to cause the live-loading member 250 to apply a gripping force, shown by arrow 255a, to maintain the gripping and/or sealing engagement of the gripping portion 222 with the tube 12. This interference fit may also maintain the live-loading member 250 in the flexed or live-loaded condition.

When a fitting is assembled with the tube gripping member 220 and live-loading member 250 on a tube 12, either upon initial pull-up or re-make of the fitting, the fitting body and nut (not shown) are tightened against the tube gripping member 220 and the live-loading member 250. In the illustrated embodiment, the fitting body of the assembled fitting seals against the fitting engaging portion 226 of the tube gripping member 220. Seals may also be achieved between one or both of the tube gripping member shoulder 223 and the tube 12, and the gripping portion 222 and the tube 12. In another embodiment (not shown), the live-loading member may be integral with the nut, such that the nut/live-loading member and tube gripping member remain locked on the tube when the fitting is disassembled.

In another embodiment, a live-loading member may interlock with another fitting component to squeeze or wedge a conduit gripping member into sustained gripping and/or sealing engagement with a conduit. In one such embodiment, as illustrated in FIG. 6, a tube gripping member 320 is provided with a gripping portion 322, a fitting engaging portion 326, and a camming portion 328. A live-loading member 350 is provided with a tube engaging portion or shoulder 352, a first interlocking portion 354, a fitting engaging portion 356, and a camming portion 358. A second live-loading member or cartridge member 360 is provided with a second interlocking portion 364, a driving portion 366, and a fitting engaging portion 368. When the tube gripping member 320 is tightened to the tube 12, the live-loading member 350 and cartridge member 360 are axially moved toward each other on the tube 12, and either or both of the first and second interlocking portions 354, 364 are elastically deformed or flexed into engagement with each other. The camming portion 358 of the live-loading member 350 and the driving portion 366 of the cartridge member 360 direct the gripping portion 322 to plastically deform the tube 12 to provide gripping and/or sealing engagement with the tube 12. The interlocking portions 354, 364 cause the live-loading member 350 and cartridge member 360 to exert gripping forces shown by arrows 358a, 366a, which maintain the gripping and/or sealing engagement of the gripping portion 322 with the tube 12. The tube 12 and gripping member 320 may also co-act with the live-loading member 350 and cartridge member 360 to maintain the live-loading member 350 and/or cartridge member 360 in the flexed or live-loaded condition.

When a fitting is assembled with the tube gripping member 320 on a tube 12, the fitting body and nut (not shown) are tightened against the live-loading member 350 and cartridge member 360. In the illustrated embodiment, the fitting body of the assembled fitting seals against the fitting engaging portion 356 of the live-loading member 350. Seals may also be achieved between one or both of the live-loading member shoulder 352 and the tube 12, and the live-loading member and gripping member camming portions 358, 328. When the fitting is disassembled, the tube gripping member 320, live-loading member 350, and cartridge member 360 remain locked on the tube 12. In another embodiment (not shown), the cartridge member may be integral with the nut, such that the nut/cartridge member, tube gripping member, and live-loading member remain locked on the tube when the fitting is disassembled.

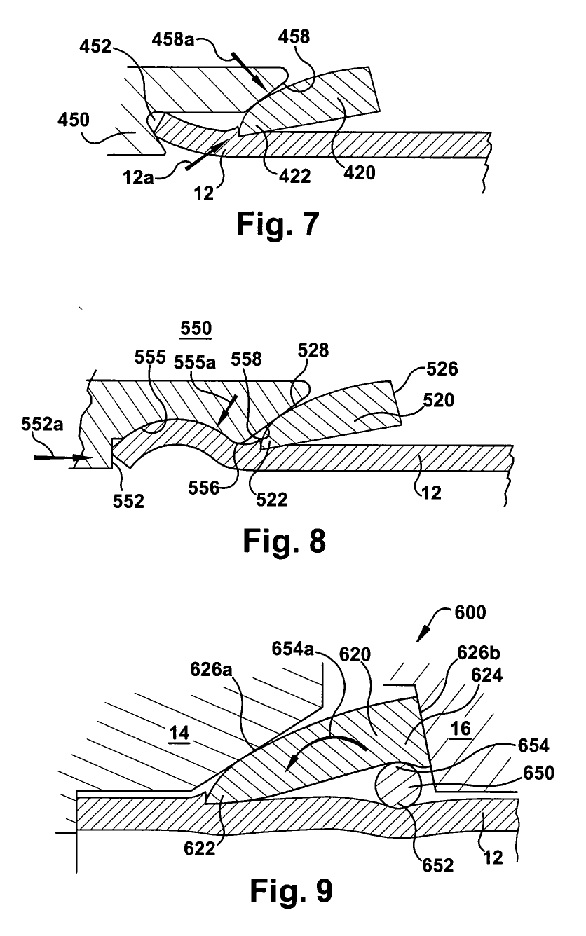

According to another inventive aspect of the present application, a live-loading member may be adapted to bend, flare, barrel, or otherwise deform a conduit end to engage or interlock the conduit end with the live-loading member, and/or to push the conduit into a sustained gripping and/or sealing engagement with the conduit gripping member when the conduit gripping member is tightened against the conduit. In one such embodiment, as shown in FIG. 7, a live-loading member 450 includes a camming surface 458 and an annular recess or shoulder 452, which may be chamfered or otherwise adapted to receive and engage an end of a tube 12. When a tube gripping member 420 is tightened onto the tube 12, the shoulder 452 causes the tube 12 to flare into engagement with the shoulder 452, while the camming surface 458 drives the gripping portion 422 of the tube gripping member 420 to plastically deform the tube 12 for a gripping and/or sealing engagement. The flared condition of the tube 12 and/or elastic deformation of the seal between the gripping member 420 and the live-loading member 450 may produce stored energy, causing the tube 12 and live-loading member 450 to exert gripping forces shown by arrows 12a, 458a. This recess and flared tube arrangement may be combined with other embodiments, such as, for example, the embodiments of FIGS. 4 and 6, to further maintain a live-loaded condition of the tube gripping member.

In another embodiment, a conduit end may be caused to barrel into an interlocking engagement with a live-loading member. In the exemplary embodiment of FIG. 8, a tube gripping member 520 is provided with a gripping portion 522, a fitting engaging portion 526, and a camming portion 528. A live-loading member 550 is provided with a tube engaging portion or shoulder 552, a camming portion 558, and an annular recess 555 that extends radially outward from a tube bore 556. When the tube gripping member 520 is tightened to the tube 12, the shoulder 552 and gripping portion 522 axially compress an end portion of the tube 12, causing the tube end portion to barrel into the annular recess 555 of the live-loading member 550, which provides a live-loaded condition in the tube end between the shoulder 552 and the recess 555, as shown by arrows 552a and 555a. This recess and barreled tube arrangement may be combined with other embodiments, such as, for example, the embodiments of FIGS. 4 and 6, to further maintain a live-loaded condition of the tube gripping member. In another embodiment (not shown), a shoulder may be provided on the fitting body instead of the gripping member for axially compressing the tube end during an initial pull-up of the fitting.

According to another inventive aspect of the present application, an annular live-loading member may be wedged between a conduit gripping member and a conduit, such that when the conduit gripping member is tightened to the conduit, the live-loading member pivots the conduit gripping member about the gripping portion to maintain a gripping and/or sealing engagement between the gripping portion and the conduit. In one such embodiment, as illustrated in FIG. 9, a tube gripping member 620 is provided with a gripping portion 622, a driven portion 624, and fitting engaging portions 626a, 626b. A live-loading member 650, schematically shown as an annular ring of circular cross-section, is provided with an inner tube engaging portion 652 and an outer drive portion 654. When the tube gripping member 620 is tightened to the tube 12 by a tightening arrangement, the live-loading member 650 is axially driven between the tube gripping member 620 and the tube 12. The drive portion 654 of the live-loading member 650 applies a pivoting force to the driven portion 624 of the tube gripping member 620, shown by arrow 654a, causing the gripping portion 622 to maintain a gripping and/or sealing engagement with the tube 12. The live-loading member 650 may also co-act with the tube 12 and the gripping member 620 to maintain the gripping member 620 and/or live-loading member 650 in a flexed or live-loaded condition.

When a fitting 600 is assembled with the tube gripping member 620 on a tube 12, either upon initial pull-up or re-make of the fitting, the fitting body 14 and nut 16 are tightened against the tube gripping member 620. In the illustrated embodiment, the fitting body 14 of the assembled fitting 600 seals against the fitting engaging portion 626a of the tube gripping member 620. Further, contact between the tube engaging portion 652 and the tube 12 may also act as a damping portion that engages the tubing upon tightening of the fitting to inhibit vibration at the end of the tubing inserted in the fitting. Examples of other fitting components with damping portions are included in the '776 application.

According to another aspect of the present application, a fitting may be provided with multiple gripping portions on one or more fitting components members to provide additional gripping and/or sealing locations on a conduit. In one such embodiment, one of the conduit gripping members may perform some additional function, such as, for example, engagement with the conduit to dampen vibrations.

Accordingly, a live-loading member may be provided with a gripping portion that cooperates with a gripping portion of a conduit gripping member to provide gripping and/or sealing engagement with the conduit. In one embodiment, the gripping portion of the conduit gripping member may provide primarily gripping engagement, while the gripping portion of the live-loading member may provide primarily sealing engagement. In another embodiment, the gripping portions of the conduit gripping member and the live-loading member may each provide both gripping and/or sealing engagement. In yet another embodiment, the gripping portion of the live-loading member may primarily serve to bias the live-loading member against the conduit gripping member to apply a sustained or live-loaded gripping force to the conduit gripping member.

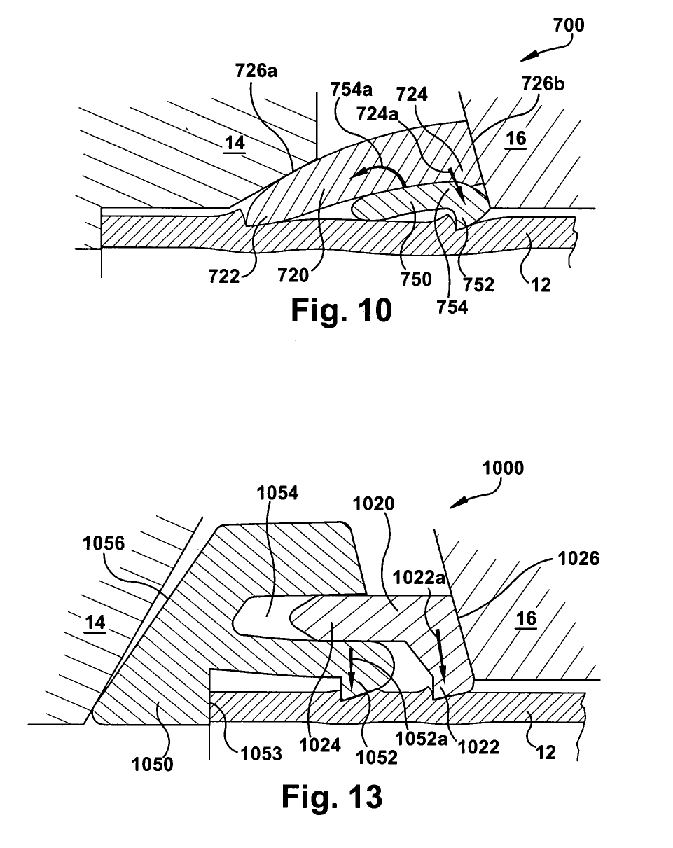

In the illustrated example of FIG. 10, a tube gripping member 720 is provided with a gripping portion 722, a driven portion 724, and fitting engaging portions 726a, 726b. A live-loading member 750 is provided with a gripping portion 752 and an outer drive portion 754. When the tube gripping member 720 is tightened to the tube 12 by a tightening arrangement, the gripping portions 722, 752 are driven to plastically deform the tube 12 for a gripping and/or sealing engagement. Additionally, the live-loading member 750 is axially driven between the tube gripping member 720 and the tube 12. The drive portion 754 of the live-loading member 750 applies a pivoting force, represented schematically by arrow 754a, to the driven portion 724 of the tube gripping member 720, causing the gripping portion 722 to maintain a gripping and/or sealing engagement with the tube 12. Further, the flexed condition of the tube gripping member 720 causes the driven portion 724 to apply a gripping force, shown by arrow 724a, to the live-loading member, causing the gripping portion 752 of the live-loading member 750 to maintain a gripping and/or sealing engagement with the tube 12. The live-loading member 750 may also co-act with the tube 12 and the gripping member 720 to maintain the gripping member 720 and/or live-loading member 750 in a flexed or live-loaded condition.

When a fitting 700 is assembled with the tube gripping member 720 on a tube 12, either upon initial pull-up or re-make of the fitting, the fitting body 14 and nut 16 are tightened against the tube gripping member 720. In the illustrated embodiment, the fitting body 14 of the assembled fitting 700 seals against the fitting engaging portion 726a of the tube gripping member 720.

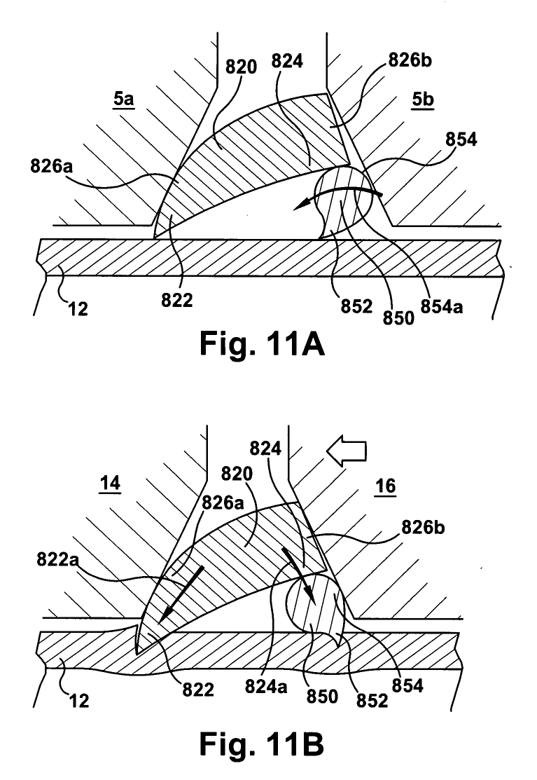

In other such embodiments, a live-loading member may be configured to hinge or pivot upon tightening into a live-loaded condition in which the live-loading member engages a conduit and transfers a pivoting gripping force to a conduit gripping member to maintain a live-loaded gripping and/or sealing engagement between the gripping member and the conduit. In the illustrated example of FIGS. 11A and 11B, a tube gripping member 820 is provided with a gripping portion 822, a driven portion 824, and fitting engaging portions 826a, 826b. A live-loading member 850 is provided with a gripping portion 852 and a drive portion 854. When the tube gripping member 820 is tightened to the tube 12 by a tightening arrangement 5a, 5b, as shown in FIG. 11A, the live-loading member 850 is pivoted or flexed to engage gripping portion 852 with the tube 12 and to pivot drive portion 854 outward, shown by arrow 854a, to engage the gripping member 820 and to pivot the gripping portion 822 into engagement with the tube 12, as shown in FIG. 11B. The resulting flexed condition of the tube gripping member 820 causes the driven portion 824 to apply a gripping force to the live-loading member, assisting the gripping portion 852 of the live-loading member 850 in maintaining a live-loaded gripping and/or sealing engagement with the tube 12. The resulting gripping forces, shown in FIG. 11B as arrows 822a and 824a, may be at least partly axially opposed to sustain a locked condition of the gripping and live-loading members 820, 850 on the tube 12 even after fitting disassembly.

In pivoting the gripping member 820 and the live-loading member 850 during tightening of the gripping arrangement, the gripping and live-loading members 820, 850 may pass through a higher load or higher mechanical potential energy condition, shown in FIG. 11A, before being deformed to a reduced load condition, as shown in FIG. 11B. While the reduced load (or live-loaded) condition provides sufficient gripping forces to maintain the desired engagement between the live-loading member 850, the gripping member 820, and the tube 12, the tendency for the gripping and live-loading members 820, 850 to bias away from their respective higher load conditions inhibits the gripping and live-loading members 820, 850 from moving out of their live-loaded conditions and passing through these higher load conditions to return to their un-flexed or non-live-loaded conditions. As such, the flexed or live-loaded condition of the gripping and live-loading members 820, 850 may be maintained without additional external forces.

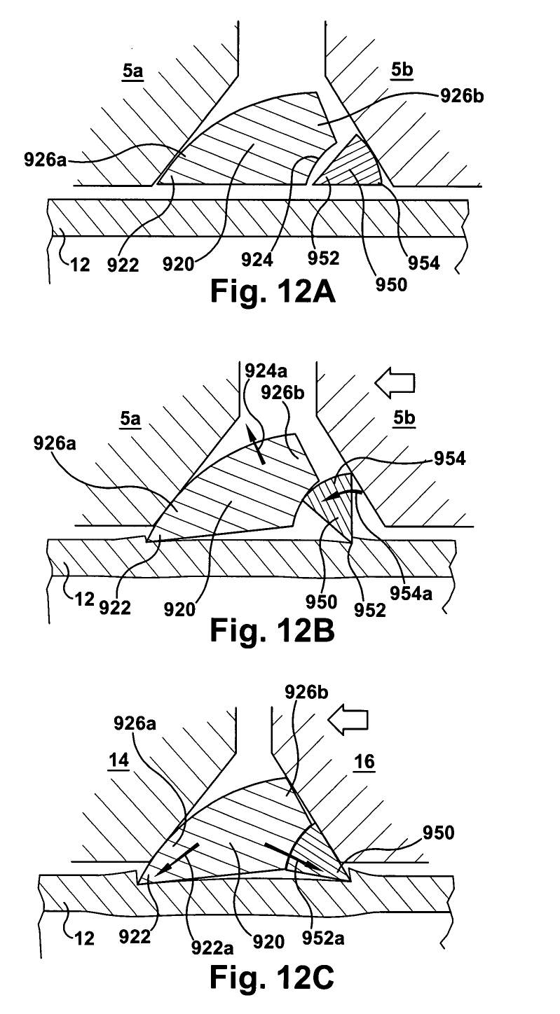

In another embodiment, a gripping member may be provided with a camming surface configured to cooperate with a pivoting live-loading member to provide a live-loaded condition in both the live-loading member and the gripping member upon tightening with a conduit. In the illustrated example of FIGS. 12A, 12B, and 12C, a tube gripping member 920 is provided with a gripping portion 922, a camming portion 924, and fitting engaging portions 926a, 926b. A live-loading member 950 is provided with a gripping portion 952, and a drive portion 954. When the gripping and live-loading members 920, 950 are tightened to the tube 12 by a tightening arrangement 5a, 5b, as shown in FIG. 12A-C, the live-loading member 950 is pivoted or flexed (as shown by arrow 954a in FIG. 12B) to engage the camming portion 924 of the gripping member 920 and to pivot or flex the gripping member such that gripping portion 922 engages the tube 12, as shown by arrow 924a in FIG. 12B. The resulting flexed or live-loaded conditions of the gripping and live-loading members 920, 950 cause the camming portion 924 to apply a gripping force to the live-loading member 950, assisting the gripping portion 952 of the live-loading member 950 in maintaining a live-loaded gripping and/or sealing engagement with the tube 12. The resulting gripping forces, shown in FIG. 12B as arrows 922a and 924a, may be at least partly axially opposed to sustain a locked condition of the gripping and live-loading members 920, 950 on the tube 12 even after fitting disassembly.

In pivoting the gripping member 920 and the live-loading member 950 during tightening of the gripping arrangement, the gripping and live-loading members 920, 950 may pass through a higher load or higher mechanical potential energy condition, shown in FIG. 12B, before being deformed to a reduced load condition, as shown in FIG. 12C. While the reduced load (or live-loaded) condition provides sufficient gripping forces to maintain the desired engagement between the live-loading member 950, the gripping member 920, and the tube 12, the tendency for the gripping and live-loading members 920, 950 to bias away from their respective higher load conditions inhibits the gripping and live-loading members 920, 950 from moving out of their live-loaded conditions and passing through these higher load conditions to return to their un-flexed or non-live-loaded conditions. As such, the flexed or live-loaded condition of the gripping and live-loading members 920, 950 may be maintained without additional external forces.

In another embodiment, a gripping member may interlock with a live-loading member, with the interlocking portions of the gripping member and live-loading member providing gripping forces to maintain sustained gripping and/or sealing engagement of gripping portions on both gripping and live-loading members with a conduit. Many different structures or configurations may be used to provide an interlocking engagement between the gripping and live-loading members. In one example of such a configuration, an axially extending annular slot may be provided in one of the gripping member and the live-loading member, and a complementary shaped axially extending projection may be provided on the other of the gripping member and the live-loading member. The slot and projection may be adapted for an interference fit, such that when the live-loading member and gripping member are axially compressed during tightening of the gripping arrangement, the live-loading member and/or gripping member flex to apply gripping forces to the gripping portions, thereby sustaining live-loaded gripping and/or sealing engagement with the conduit.

In the illustrated embodiment of FIG. 13, a tube gripping member 1020 is provided with a gripping portion 1022, a projecting portion 1024, and a fitting engaging portion 1026. A live-loading member 1050 is provided with a gripping portion 1052, a tube engaging shoulder portion 1053, an annular slot portion 1054, and a fitting engaging portion 1056. When the tube gripping member 1020 and live-loading member are tightened to the tube 12 by a tightening arrangement, the gripping portions 1022, 1052 are driven to plastically deform the tube 12 for a gripping and/or sealing engagement. Additionally, the projecting portion 1024 of the tube gripping member 1020 is axially driven into the annular slot portion 1054 of the live-loading member 1050. An interference fit between the projecting portion 1024 and the slot portion 1054 may be provided to cause the gripping portion 1052 of the live-loading member 1050 to flex toward the tube 12, to cause the gripping portion 1022 of the tube gripping member 1020 to be pulled against the tube 12. The resulting live-loaded gripping forces, shown by arrows 1022a, 1052a, provide a sustained gripping and/or sealing engagement between the gripping portions 1022, 1052 and the tube 12.

When a fitting 1000 is assembled with the tube gripping member 1020 on a tube 12, either upon initial pull-up or re-make of the fitting, the fitting body 14 and nut 16 are tightened against the live-loading member 1050 and tube gripping member 1020. In the illustrated fitting assembly 1000, the fitting body 14 seals against the fitting engaging portion 1056 of the live-loading member 1050.

According to the present application, other features or properties may be provided with a fitting assembly to enhance the gripping, sealing, or other performance characteristics of the conduit gripping member or other fitting components. For example, many different sealing arrangements may be provided to achieve a seal between fitting coupling components, such as a fitting body or coupling nut, and either the conduit gripping member or the live-loading member. As one example, the fitting component and the live-loading or conduit gripping member may be provided with opposed sealing surfaces that engage each other to create a seal, as shown, for example, in FIGS. 2B, 3B, 10, and 13. In one embodiment, one or both of the opposed sealing surfaces may be deformable upon tightening of the fitting and engagement of the sealing surfaces, such that a leak tight seal is achieved. One or both of these surfaces may also be incrementally deformable so as to allow the surfaces to create new seals upon subsequent re-makes or retightening of the fitting. In another embodiment, one of the surfaces may be hardened to assist in deformation of the opposite surface. In yet another embodiment, the live-loading or conduit gripping member may be provided with an annular indenting edge that is adapted to indent the mating seal surface of the fitting component. In still another embodiment, a gasket or other sealing component may be disposed between the live-loading or conduit gripping member and the fitting component to provide a seal. Several exemplary sealing arrangements are disclosed in the '776 application.

While the gripping portions of the illustrated embodiments of FIGS. 2A-11 are shown as sharp cutting edges, barbs, or inwardly angled nose portions, as another example of additional or alternative features or properties, the gripping portion may take many different shapes or configurations, including, for example, one or more spikes or teeth, or knurled or frictional bands or regions (not shown). Additionally or alternatively, a frictional or other such surface may be adapted to gall with the conduit to provide a permanent grip. In another embodiment, this dry-friction galling may be used to interlock a conduit gripping member with a live-loading member.

As another example of additional or alternative features or properties, all or part of a conduit gripping member may be hardened to provide an improved grip or deformation of a conduit end. For example, the conduit gripping members of each of the illustrated embodiments may be hardened. A harder indenting edge or gripping portion experiences less deformation while the indenting edge plastically deforms the tubing, which also results in lower force required to plastically deform the conduit. In an exemplary embodiment, the gripping portion has a Rockwell hardness scale C hardness between R_{c} 40 and R_{c} 70. Examples of hardening techniques that can be employed include, but are not limited to, case hardening, work hardening, and hardening using a low temperature carburization process. The entire gripping member may be hardened, or only a portion of the gripping member, such as the gripping portion may be hardened. One process that can be used to harden the gripping portion without hardening the remainder of the gripping member is disclosed in U.S. Pat. No. 6,165,597, entitled “Selective Case Hardening Processes at Low Temperature” to Williams et al., which is incorporated herein by reference in its entirety. The gripping member to be hardened may be made from any suitable material, including, for example, nickel alloys, titanium, copper alloys, steel, stainless steel, such as 316 stainless steel, and other metals.

As still another example of additional or alternative features or properties, a fitting component, such as a conduit gripping member or live-loading member, may be made from a shape memory alloy, such that when the fitting component is made to return to a “remembered” shape, a sustained gripping force is applied to a gripping portion of the conduit gripping member to maintain gripping and/or sealing engagement with the conduit. Many different shape memory alloys may be used. Some examples of suitable shape memory alloy are disclosed in U.S. patent application Publication No. 2006/0151069, Ser. No. 11/327,011, entitled “Carburization of Ferrous-based Shape Memory Alloys,” filed on Jan. 6, 2006, which is incorporated herein by reference in its entirety.

As yet another example of additional or alternative features or properties, a substance may be applied to one or more fitting components, such as a conduit gripping member or live-loading member, to enhance fitting performance. For example, a lubricant may be applied to a fitting component to attenuate vibrations, retard oxidation, and/or disperse debris. Examples of suitable lubricants and methods of applying the lubricants to tube fittings are disclosed in PCT application US/06/03909, entitled “Fitting with Lubricated Ferrule,” filed on Feb. 6, 2006 and published United States patent application Publication Number 2003/0155045, Ser. No. 10/358,946, entitled “Lubricated Low Temperature Carburized Stainless Steel Parts,” filed on Feb. 5, 2003, which are incorporated herein by reference in their entirety.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A fitting for a conduit, the fitting comprising:
a first fitting component adapted to receive a conduit along a central axis;
a gripping member comprising a gripping portion adapted to engage the conduit when the gripping member is tightened to the conduit;
a second fitting component adapted to be joined to the first fitting component to provide a seal between the gripping member and at least one of the first and second fitting components; and
a live-loading mechanism adapted to hold the gripping member in live-loaded engagement with the conduit when the first fitting component is separated from the second fitting component.

2. The fitting of claim 1, wherein the live-loading mechanism comprises a flexing portion of the gripping member that elastically deforms into a flexed position when the gripping member is tightened to the conduit.

3. The fitting of claim 2, wherein the flexing portion is configured to be flexed beyond a condition of elevated potential energy to a condition of less elevated potential energy, such that the gripping member resists movement out of the condition of less elevated potential energy when the gripping member is no longer being tightened to the conduit.

4.-14. (canceled)

15. The fitting of claim 1, wherein the gripping portion is configured to produce an area of plastic deformation in the conduit, further wherein the live-loading mechanism is configured to prevent elastic movement of the gripping portion with respect to the area of plastic deformation in the conduit when the first fitting component is separated from the second fitting component.

16. A gripping arrangement for a fitting, the arrangement comprising:
a gripping member comprising a gripping portion configured to grip conduit to form an area of plastic deformation in the conduit when the gripping member is tightened to the conduit; and
a live-loading mechanism configured to hold the gripping member in live-loaded engagement with the area of plastic deformation in the conduit when the gripping member is no longer being tightened to the conduit.

17. The gripping arrangement of claim 16, wherein the live-loading comprises a flexing portion of the gripping member that elastically deforms into a flexed position when the gripping member is tightened to the conduit.

18. The gripping arrangement of claim 17, wherein the flexing portion is configured to be flexed beyond a condition of elevated potential energy to a condition of less elevated potential energy, such that the gripping member resists movement out of the condition of less elevated potential energy when the gripping member is no longer being tightened to the conduit.

19. A method for maintaining gripping engagement between a conduit and an annular gripping member for a fitting, the method comprising:
tightening the annular gripping member around the conduit to grip the conduit;
elastically deforming a live-loading mechanism to store mechanical energy; and
directing the stored mechanical energy from the live loading mechanism into the gripping member such that the gripping member maintains live-loaded engagement with the conduit when the gripping member is no longer being tightened to the conduit.

20. The method of claim 19, wherein tightening the annular gripping member around the conduit comprises flexing the live-loading mechanism beyond a condition of elevated potential energy to a condition of less elevated potential energy, such that the annual gripping member resists movement out of the condition of less elevated potential energy when the annular gripping member is no longer being tightened to the conduit.

21. The fitting of claim 1, wherein the gripping member comprises first and second axially spaced gripping portions.

22. The fitting of claim 2, wherein the gripping member comprises first and second gripping portions axially spaced by the flexing portion.

23. The fitting of claim 2, wherein the gripping member comprises first and second fitting engaging portions axially spaced by the flexing portion.

24. The fitting of claim 23, wherein the first fitting engaging portion is configured to engage the first fitting component, and the second fitting engaging portion is configured to engage the second fitting component.

25. The fitting of claim 23, wherein when the first fitting component is tightened with the second fitting component, the first and second fitting engaging portions are axially compressed to elastically deform the flexing portion into a flexed condition.

26. The fitting of claim 23, wherein when the first fitting component is tightened with the second fitting component, the first and second fitting engaging portions are radially compressed to force the gripping portion into gripping engagement with the conduit.

27. The gripping arrangement of claim 16, wherein the gripping member comprises first and second axially spaced gripping portions.

28. The gripping arrangement of claim 17, wherein the gripping member comprises first and second gripping portions axially spaced by the flexing portion.

29. The fitting of claim 17, wherein the gripping member comprises first and second fitting engaging portions axially spaced by the flexing portion.

30. The method of claim 19, wherein tightening the annular gripping member around the conduit to grip the conduit comprises forcing first and second axially spaced gripping portions of the gripping member into gripping engagement with the conduit.

31. The method of claim 19, wherein elastically deforming the live-loading mechanism to store mechanical energy comprises axially compressing the gripping member to elastically deform a flexing portion of the gripping member to a flexed position.
